(19) United States
(12) Patent Application Publication
(10) Pub. No.: US 2003/0181072 A1
(43) Pub. Date: Sep. 25, 2003

(54) Circuit card having recessed terminal array

(76) Inventors: Edward M. Staples, St Albans (GB); Stephen R. Murley, Heath and Reach (GB)

Correspondence Address: NIXON & VANDERHYE P.C., 8th Floor, 1100 North Glebe Rd., Arlington, VA, 22201-4714, US

(21) Appl. No.: 10/136,341

(22) Filed: May 2, 2002

(30) Foreign Application Priority Data
Mar. 23, 2002 (GB) 0206890.6

(51) Int. Cl. H01R 12/00

(52) U.S. Cl. 439/59

(57) ABSTRACT

A circuit card which has along one edge a tab bearing an array of terminal contacts, and neighbouring wings relative to which the tab is inwardly recessed whereby the tab is protected against physical damage.

### FIELD OF THE INVENTION

This invention relates to a circuit card (otherwise called variously circuit board, printed circuit board etc) which has at least one edge along and adjacent part of which is disposed an array of terminal contacts. The invention is particularly concerned with a circuit card which is especially adapted to protect the terminal contact array from damage which might occur during transport, unpacking or more generally by virtue of rough or careless handling of the circuit card.

### BACKGROUND TO THE INVENTION

Many forms of electrical and electronic equipment are now constituted by one or more stiff boards (hereinafter called cards) which may carry a vast multiplicity and variety of electrical circuit components including integrated circuit components, discrete components and suchlike, depending on the functionality of the circuit or partial circuit which is carried by the card. The card may include printed circuit connections between the various components. The use of such cards has become exceedingly commonplace as a result of automated manufacture and is generally convenient from the point of view of servicing, upgrading of an electronic unit and many other purposes which are well known and do not require detailed discussion.

Very many varieties of card include along part of at least one edge an array of terminal pads of a predetermined number and spacing, generally extending close to the relevant edge of the printed circuit board on a prominence or protruding part which is delimited by a slot at each end. This form of terminal array is very popular because it allows for the easy insertion of the board into a multiple contact edge connector such as described for example in U.S. Pat. No. 5,387,132 issued Feb. 7, 1995 to Sarva et al, U.S. Pat. No. 5,470,240 issued Nov. 28, 1995 to Suzuki, U.S. Pat. No. 4,241,381 issued Dec. 23, 1980 to Cobaugh et al and so on.

Cards of this general kind have a susceptibility to damage owing to the nature of the ‘edge array’ of terminals. These are necessarily close to the edge of the card and accordingly if the card is dropped, awkwardly inserted into a connector or otherwise roughly handled, physical damage to the terminal-carrying edge of the card can easily occur.

It is known to provide a circuit card support frame for protecting and transporting a circuit card, as disclosed in U.S. Pat. No. 5,303,820 issued Apr. 19, 1994 to Comtois.

The object of the invention is to provide an improved circuit card by means of a novel shaping of the circuit card, particularly along the edge which carries the edge array of terminal contacts.

### SUMMARY OF THE INVENTION

In a preferred form of the present invention a circuit card has along one edge of the card a tab bearing an array of contacts, the tab being recessed relative to neighbouring edge portions. In one preferred arrangement, the card has at least two wings having co-linear edge portions and at least one intermediate terminal tab, delimited by a slot on each side of the or each tab, and being spaced inwardly relative to the wings.

In a further development of the invention, the first and second edge portions of the wings may be connected to a sacrificial strip which extends outwardly relative to the first and second portions and which is adapted to break easily and cleanly from said portions so that these edge portions can themselves be protected against handling damage.

Further features of the invention will become apparent from the following detailed description and the accompanying drawings.

### BRIEF DESCRIPTION OF THE DRAWING

FIG. 1 is a schematic plan view of a circuit card constituting one embodiment of the invention.

FIG. 2 is a plan view of another embodiment of the invention.

FIG. 3 shows part of the embodiment of FIG. 1 in greater detail.

### DETAILED DESCRIPTION

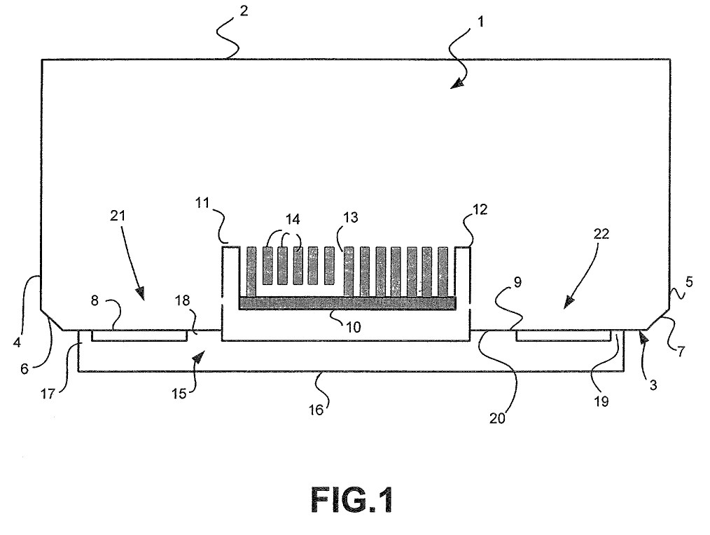

FIG. 1 illustrates schematically a circuit card 1 according to the invention. This circuit card may be a printed circuit board having a multiplicity of connections between electrical and electronic components disposed on one side or another (or both) of the circuit card. The components may include integrated circuits, discrete components such as individual inductors, capacitors, switches and suchlike. The printed circuit and the various components are for the sake of convenience not illustrated mainly because the particular layout of the card is not of any great relevance to the invention. However, whatever may be the particular purpose or functionality of the circuit card, a circuit card according to the invention will have along at least one edge an edge array of terminal contacts. It is the protection of these terminal contacts with which the present invention is primarily concerned.

It is conventional and convenient to manufacture circuit cards in, often, standard sizes and normally with a standard generally rectangular shape. In the present example the card 1 has a rear generally straight edge 2, a front edge 3 and two side edges 4 and 5, edges 2 to 5 being generally the sides of a rectangle. For possible convenience of insertion and also to avoid or minimise damage, the corners between the front edge 3 and each of the side edges 4 and 5 have a 45° chamfer 6 and 7 respectively.

In this embodiment of the invention the front edge 3 of the card 1 has three principal portions 8, 9 and 10. The portions 8 and 9 are substantially co-linear whereas the portion 10 which is intermediate the portions 8 and 9 is substantially recessed inwardly so that there is a significant spacing between the edge portion 10 and the two edge portions 8 and 9 which flank it. The edge portion 10 is delimited by two slots 11 and 12 the sides of which are preferably at right-angles to the direction of edge portions 8 and 9 and which define a base line for the terminal pads to be described. The leading edge of portion 10 is chamfered so as to facilitate insertion into an edge connector.

The slots 11 and 12 and the edge portion 10 define a terminal tab 13 of which the base or datum line (not shown) is aligned with the inner ends of the slots 11 and 12. On this tab 13 is disposed an array of terminal pads 14. These are preferably conductive strips extending at right-angles to the edge portion 10. Preferably they each extend, selectively for various distances, from the datum line of tab 13 towards the edge 10.

The card 1 as thus far described has a degree of protection against damage, arising from the dropping of the card, rough handling or otherwise, since the tab 13 is substantially recessed relative to the wings 21 and 22 defined by edge portions 8 and 9. These wings can bear the brunt of damage if, for example, a card is dropped and the edge 3 sustains physical damage.

It will be understood that there may be a multiplicity of terminal carrying tabs 13 along the same edge of the printed circuit board, each one being delimited by adjacent slots and recessed relative to edge portions in the manner described. How many such terminal arrays are provided along an edge of the card is a matter of design choice.

Single recessed tabs may alternate with wings along the edge or, as described below, there may be two or more consecutive terminal tabs between a pair of ‘neighbouring’ wings.

The presently described embodiment has a further feature which can provide some protection for the edge portions 8 and 9. These edge portions may be sacrificial in that damage to them may be tolerated. If however they are required to be substantially free of damage, so that they may continue to be inserted without difficulty into some card slot or otherwise, additional protection for these edges may be appropriate.

The embodiment shown in FIG. 1 includes a sacrificial part 15 constituted by a strip which extends along the edge 3, preferably being joined to the edge portions 8 and 9 and thereby spanning the recessed tab 13. Thereby it provides additional protection for the tab 13. In the present embodiment sacrificial part 15 is connected to the edge portions 8 and 9 by means of integral lugs 17 and 18 to edge portion 8 and integral lugs 19 and 20 to edge portion 9. Lugs 17 to 20 are preferably connected to edge portions 8 and 9 as the case may be with a line of weakness formed along the boundary of the lugs and the edge portions 8 and 9. Thereby the sacrificial strip 15 can be neatly severed easily from the edge portions 9.

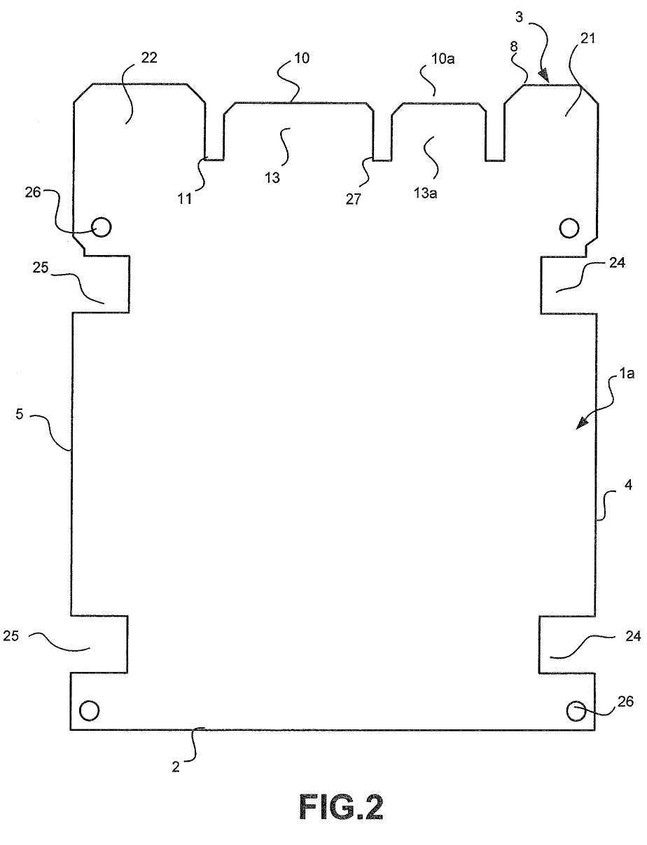

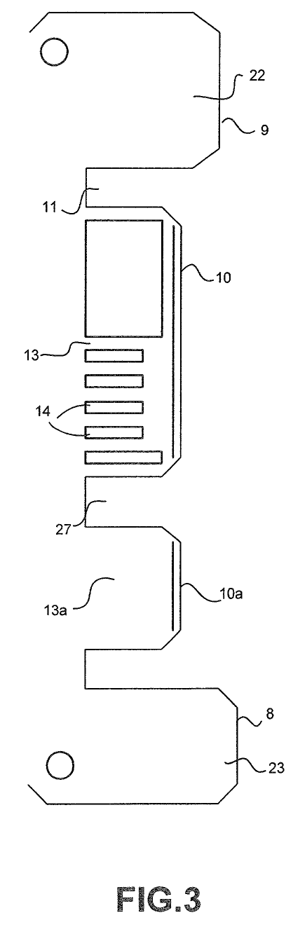

FIGS. 2 and 3 illustrate another and preferred embodiment of the invention. In this embodiment the sides 4 and 5 of the card 1a have side slots 24 and 25 and the card is formed with four indexing holes 26.

As is shown in FIG. 2, the front edge part 3 includes two consecutive terminal tabs 13 and 13a which are recessed relative to the neighbouring wings 21 and 22. Tab 10 is laterally delimited by slots 11 and 27 whereas tab 10a is laterally delimited by slots 27 and 12. Slot 27 should be wide enough to allow separate edge connectors to engage tabs 13 and 13a. each of the wings 21 and 22 and each of the tabs 10 and 10a are bevelled at each side to aid insertion where appropriate and to lessen susceptibility to damage.

FIG. 3 illustrates the front edge part 3 of the card 1a in greater detail: the tab 13 is shown as including the terminal strips 14. These are omitted from tab 13a for simplicity.

In a specific example, the common line extending along the leading edges of edge portions 10 and 10a of tabs 13 and 13a are offset inwardly by 4.3 mm from common line extending along the leading edges of neighbouring edge portions 8 and 9. The length of the card may be approximately 170 mm, the width approximately 100 mm and the thickness 1.6 mm. Obviously the dimensions can be varied to suit the circumstances; an inward displacement of the tab or tabs from the wings of between 3 and 6 mm may be provided.

1. A circuit card including a rear edge, side edges and a front edge, wherein said front edge comprises two wings and between said wings at least one tab having a leading edge and carrying an array of terminal contacts adjacent said leading edge, said leading edge of said tab being recessed relative to said wings in a direction towards said rear edge.

2. A circuit card according to claim 1 wherein said wings have substantially co-linear leading edges, said leading edge of said tab being spaced spaced inwardly from said co-linear edges.

3. A circuit card according to claim 1 wherein the tab is delimited on each side thereof by a respective slot.

4. A circuit card according to claim 1 wherein a sacrificial strip is joined to the wings to extend across the tab.

5. A circuit card according to claim 4 wherein said sacrificial strip has lugs which are joined to the wings along a line of weakness.

6. A circuit card according to claim 1 wherein there are at least two adjacent tabs both disposed between said wings and separated by an intermediate slot.

7. A circuit card including a rear edge, first and second side edges and a front edge, wherein said front edge comprises:
(a) first and second wings each having a leading edge, the leading edges of said first and second wings being substantially colinear;
(b) at least one tab having a leading edge and carrying an array of terminal contacts adjacent said leading edge of the tab; and
(c) slots at each side of said tab;
and wherein said leading edge of said tab is recessed relative to said leading edges of said wings.

8. A circuit card including a rear edge, first and second side edges and a front edge, wherein said front edge comprises:
(a) first and second wings each having a leading edge, said leading edges of said first and second wings being substantially colinear;
(b) at least one tab located between said wings, the tab having a leading edge and carrying an array of terminal contacts adjacent said leading edge of the tab; and
(c) slots extending towards said rear edge to delimit said tab at each side thereof;
and wherein said leading edge of said tab is recessed relative to said leading edges of said wings.

9. A circuit card including a rear edge, first and second side edges and a front edge, wherein said front edge comprises:
(a) first and second wings each having a leading edge, said leading edges of said first and second wings being substantially colinear;
(b) at least two tabs each having a leading edge and carrying an array of terminal contacts adjacent the leading edge of the respective tab; and
(c) slots at each side of each tab;
and wherein said leading edge of said tab is recessed relative to said leading edges of said wings.

10. A circuit card including a rear edge, first and second side edges and a front edge, wherein:
said front edge comprises:
(a) first and second wings each having a leading edge, said leading edges of said first and second wings being substantially colinear;
(b) at least one tab located between said wings, the tab having a leading edge and carrying an array of terminal contacts adjacent said leading edge of the tab; and
(c) slots at each side of said tab;
and wherein said leading edge of said tab is recessed by between 3 and 6 millimetres relative to said leading edges of said wings.
